(19) United States
(12) Patent Application Publication
(10) Pub. No.: US 2007/0030852 A1
(43) Pub. Date: Feb. 8, 2007

(54) Method and apparatus for enabling routing of label switched data packets

(76) Inventors: Mark Szczesniak, Carlisle, MA (US); Francois Laurent Le Faucheur, Valbonne (FR); Johnny Dean Poulin, Kittery Point, ME (US)

Correspondence Address: HICKMAN PALERMO TRUONG & BECKER, LLP, 2055 GATEWAY PLACE, SUITE 550, SAN JOSE, CA, 95110, US

(21) Appl. No.: 11/199,938

(22) Filed: Aug. 8, 2005

(51) Int. Cl. H04L 12/56

(52) U.S. Cl. 370/392; 370/255

(57) ABSTRACT

A method of enabling routing of label switched data packets in a data communications network comprising a plurality of nodes and supporting multiple topologies, is performed at an enabling node and comprises constructing a per-topology label forwarding table.

### CROSS-REFERENCE TO RELATED APPLICATIONS

This application is related to a co-pending application entitled “Method and Apparatus for Enabling Routing of Label Switched Data Packets,” of Mark Szczesniak et al., filed on even date herewith, Attorney Docket No. 50325-1124, the entire contents of which is hereby incorporated by reference as if fully set forth herein.

### FIELD OF THE INVENTION

The present invention generally relates to enabling routing of data packets. The invention relates more specifically to a method and apparatus for enabling routing of label switched data packets.

### BACKGROUND OF THE INVENTION

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

In computer networks such as the Internet, packets of data are sent from a source to a destination via a network of elements including links (communication paths such as telephone or optical lines) and nodes (for example, routers directing the packet along one or more of a plurality of links connected to it) according to one of various routing protocols.

In some instances networks are capable of supporting multi-topology routing. Multi-topology routing is described in “MT-OSPF: Multi-topology (MT) routing in OSPF” by Pseniak et al, which is available at the time of writing from the file “draft-ietf-ospf-mt-04.txt” in the directory “internet-drafts” of the domain “ietf.org” on the World Wide Web.

In multi-topology routing one or more additional topologies are overlaid on a base or default topology and different classes of data are assigned to different topologies and classified accordingly during the forwarding operation. For example the base or default topology will be the entire network and an additional topology will be a subset of the default topology. It will be appreciated that the physical components of the network are common to both topologies but that for various reasons it may be desirable to assign certain classes of traffic to only a certain subset of the entire network as a result of which the multi-topology concept provides a useful approach to providing this functionality. Alternatively, links may have different metric values in different topologies (and all links may be included in all topologies).

One example of the use of multiple topologies is where one class of data requires low latency links, for example Voice over Internet Protocol (VoIP) data. As a result such data may be sent preferably via physical landlines rather than, for example, high latency links such as satellite links. As a result an additional topology is defined as all low latency links on the network and VoIP data packets are assigned to the additional topology. Another example is security-critical traffic which may be assigned to an additional topology of non-radiative links. Further possible examples are file transfer protocol (FTP) or SMTP (simple mail transfer protocol) traffic which can be assigned to an additional topology comprising high latency links, Internet Protocol version 4 (IPv4) versus Internet Protocol version 6 (IPv6) traffic which may be assigned to different topologies or data to be distinguished by the quality of service (QoS) assigned to it.

Multi-topology routing is supported in the context, for example, of Internet protocol (IP) link state routing protocols such as OSPF and IS-IS. The link state protocol relies on a routing algorithm resident at each node. Each node on the network advertises, throughout the network, links to neighboring nodes and provides a cost associated with each link, which can be based on any appropriate metric such as link bandwidth or delay and is typically expressed as an integer value. A link may have an asymmetric cost, that is, the cost in the direction AB along a link may be different from the cost in a direction BA. Based on the advertised information in the form of a link state packet (LSP) each node constructs a link state database (LSDB), which is a map of the entire network topology, and from that constructs generally a single optimum route to each available node based on an appropriate algorithm such as, for example, a shortest path first (SPF) algorithm. As a result a “spanning tree” (SPT) is constructed, rooted at the node and showing an optimum path including intermediate nodes to each available destination node. The results of the SPF are stored in a routing information base (RIB) and based on these results the forwarding information base (FIB) or forwarding table is updated to control forwarding of packets appropriately. When there is a network change an advertisement representing the change is flooded through the network by each node adjacent the change, each node receiving the advertisement sending it to each adjacent node.

As a result, when a data packet for a destination node arrives at a node (the “first node”), the first node identifies the optimum route to that destination and forwards the packet to the next node along that route. The next node repeats this step and so forth.

In the case of MTR, each advertisement is topology specific and includes a field identifying the topology (field MT-ID). As a result each router runs a separate SPF for each MT-ID and, from that, constructs a separate RIB and corresponding FIB. When a packet arrives at a multi-topology capable router it is classified in order to identify its MT-ID and the relevant next hop derived from the corresponding RIB/FIB.

However no solutions are currently proposed for supporting multi-topology routing in the multi protocol switching (MPLS) forwarding environment.

MPLS is a protocol that is well known to the skilled reader and which is described in document “Multi Protocol Label Switching Architecture” which is available at the time of writing on the file “rfc3031.txt” in the directory “rfc” of the domain “ietf.org” on the World Wide Web (“RFC3031”). According to MPLS, a complete path for a source-destination pair is established, and values required for forwarding a packet between adjacent routers in the path together with headers or “labels” are pre-pended to the packet. The labels are used to direct the packet to the correct interface and next hop. The labels precede the IP or other header allowing smaller outer headers.

The path for the source-destination pair, termed a Label Switched Path (LSP) can be established according to various different approaches. One such approach is Label Distribution Protocol (LDP) in which each router in the path sends its label to an adjacent router on the path as determined from its IP routing table. Alternatively Resource Reservation Protocol (RSVP) can be invoked in which case, for example, a network administrator can engineer a path, providing strict source routing.

For each LSP created, a forwarding equivalent class (FEC) is associated with the path specifying which packets are mapped to it. For example all packets for destinations served by a given prefix may be assigned to the same FEC. Assignment of the packet to an FEC is carried out at the ingress router to the MPLS network which attaches the appropriate label for the packet for the next hop router in the MPLS path.

In MPLS therefore adjacent routers swap ingress and egress labels. Adjacent routers, in particular, bind a label to an FEC and advertise the binding information to the adjacent router such that when a packet is received at the router with the advertised label as ingress label, the router is able to identify the FEC and replace the ingress label with an egress label for that FEC which it, in turn, has been received from the next downstream router. The ingress and egress a given FEC are then associated with one another in a label forwarding information base (LFIB) together with the next hop for that FEC derived from the RIB.

However the MPLS control plane and MPLS forwarding plane are not currently are and therefore cannot take advantage of MTR class based routing.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a representation of a network illustrating a method of enabling routing as described herein;

FIG. 2 is a flow diagram illustrating steps performed according to the method at a label advertising router;

FIG. 3 is a flow diagram illustrating the steps performed according to the method at a label advertisement receiving router;

FIG. 4a shows an RIB at a router for a first topology;

FIG. 4b shows an RIB at the same router for a second topology;

FIG. 5a shows an LFIB for a first topology at a router;

FIG. 5b shows an LFIB for a second topology at the same router;

FIG. 6 is a flow diagram illustrating a forwarding operation at a router according to the method described herein; and

FIG. 7 is a block diagram that illustrates a computer system upon which a method may be implemented.

### DETAILED DESCRIPTION OF THE PREFERRED EMBODIMENT

A method and apparatus for enabling routing of label switched data packets is described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Embodiments are described herein according to the following outline:

1.0 General Overview

2.0 Structural and Functional Overview

3.0 Method of Enabling Routing of Label Switched Data Packets

4.0 Implementation Mechanisms—Hardware Overview

5.0 Extensions and Alternatives

1.0 General Overview

The needs identified in the foregoing Background, and other needs and objects that will become apparent for the following description, are achieved in the present invention, which comprises, in one aspect, a method of enabling routing of label switched data packets in a data communications network comprising a plurality of nodes and supporting multiple topologies, the method being performed at an enabling node and comprising constructing a per-topology label forwarding table.

In other aspects, the invention encompasses a computer apparatus and a computer-readable medium configured to carry out the foregoing steps.

2.0 Structral And Fuctional Overview

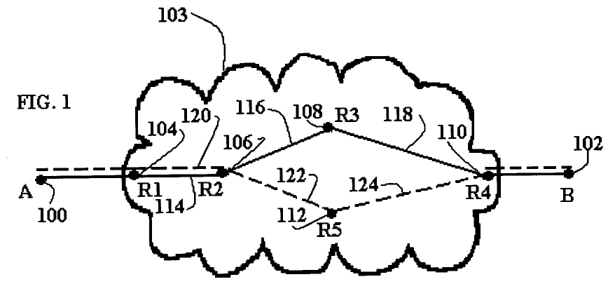

In overview a method for enabling routing of label switched data packets can be understood with reference to FIG. 1 which depicts an illustrative network diagram to which the method is applied. The network includes source and destination nodes A, B, reference number 100, 102 and an MPLS network generally designated 103 including an ingress router R1, reference number 104, and an egress router R4, reference numeral 110 together with additional routers R2, R3 and R5, reference numerals 106, 108, 112 respectively. The network supports a first topology (topology 1) shown in a solid line providing a path along R1, R2, R3, and R4 via links 114, 116, 118. The network further supports a second topology (topology 2) shown in dotted lines providing a path along R1, R2, R5, and R4 via links 120, 122, 124. For example the first topology may be for secure traffic only and hence comprise non-radiative links only whereas the second topology may be for time critical traffic such as VoIP and comprise the fastest available links. As a result it is desirable to ensure that data packets are classified and forwarded according to the appropriate topology.

In order to enable routing of MPLS packets per topology multiple forwarding tables, i.e., LFIBs are established and maintained, one for each topology. Each LFIB is populated with ingress and egress labels advertised/received by the router maintaining the LFIB together with next hop information from the RIB (of the corresponding topology) which itself is derived from MTR aware routing protocols such as MT-OSPF described above. For example in the case of the topology shown in FIG. 1, router R2 will maintain an LFIB for each of the first and second topologies with R3 and R5 as respective next hops together with their respective egress labels. Then when a label switched packet is received at router R2, it is first classified to identify the appropriate topology, and then forwarded according to the forwarding path defined by the LFIB corresponding to that topology. As a result traffic can be forwarded through the MPLS network along class-based paths established by MTR routing without any extension to MPLS protocols such as label distribution protocol messages.

3.0 Method of Enabling Routing of Label Switched Data Packets

For purposes of illustrating a clear example, the method described herein in some instances refers to its applicability in relation to a network of the type shown in FIG. 1. However the method described herein is not limited to the context of FIG. 1 and may be applied to any appropriate multi-topology routing domain.

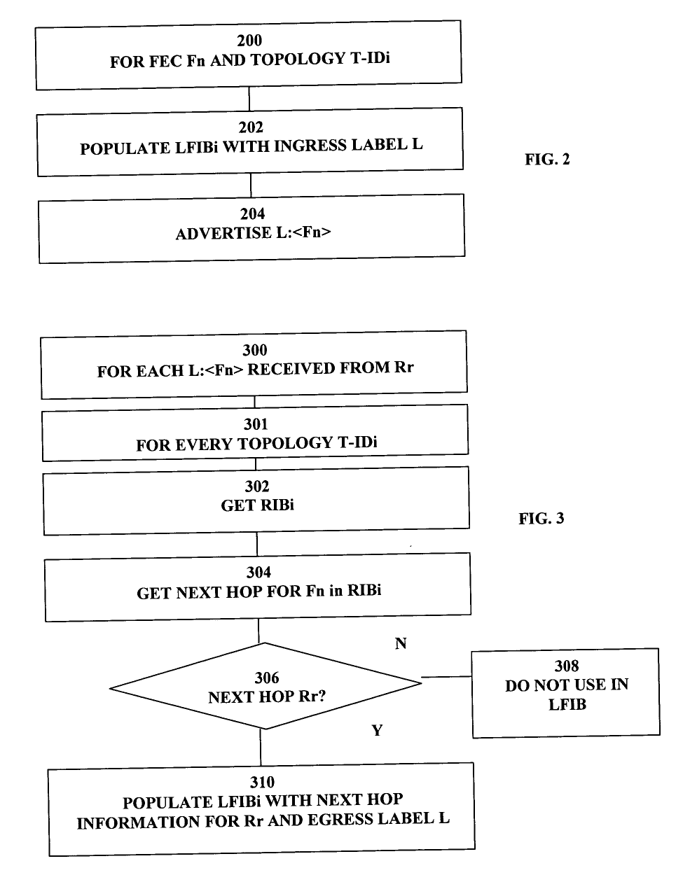

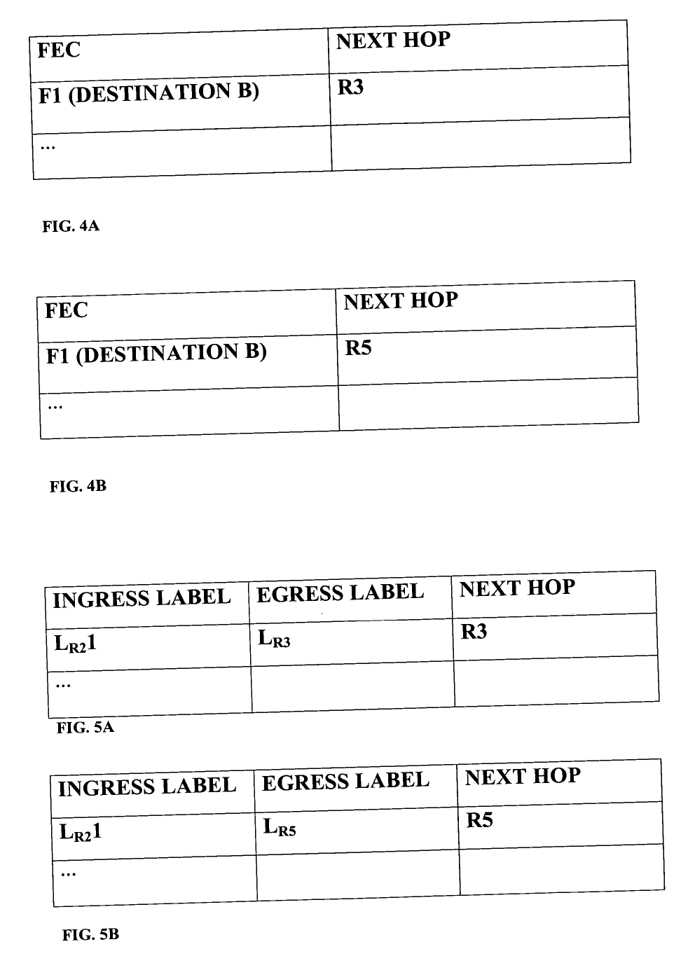

Referring to FIG. 2 which shows a flow diagram illustrating in more detail the method described herein, the steps performed by an enabling node, in the present example, node R2 acting as a label advertising node, can be understood with reference to FIGS. 4a and 4b which show per topology RIBs maintained at router R2 and constructed, for example, according to IP-routing or any other appropriate MTR aware routing protocol and FIGS. 5a and 5b which show per topology LFIBs at router R2.

At step 200, for each topology, that is topology 1 and topology 2, router R2 populates the LFIB at step 202 with the label it will advertise for each FEC. In the present case, for FEC F1, that is packets destined for node B, router R2 populates its respective LFIBs for topology 1 and topology 2 with its label L_{R2}1 for that FEC. Then, at step 204, router R2 advertises its label via label binding L_{R2}1<F1>. It will be noted that router R2 signals the same label for that FEC for all topologies and, as described in more detail below, then uses IP MTR-aware knowledge to forward data packets on a per-topology basis.

Turning now to FIG. 3 which is a flow diagram illustrating the steps performed at router R2 as a receiving node receiving advertisements from downstream routers for each label binding advertisement received from a router Rr at step 300 for each topology Tᵢ, which R2 can identify from MTR-aware information available according to other protocols, the RIB for that topology RIBi is identified at step 302 and, for the relevant FEC, router R2 obtains the appropriate next hop at step 304. Then, at step 306, if the next hop obtained at step 304 is the router Rr which advertised the processed label advertisement at step 308 router R2 populates in the corresponding LFIBᵢ entry an ingress label which has the label value advertised by R2 for that FEC, the next hop (Rr) for that FEC obtained at step 304 and an egress label which is the label L advertised by that next hop router (Rr) for that FEC in the processed label advertisement. At step 310, if the next hop obtained at step 304 is not the router Rr which advertised the processed label advertisement, then that label advertisement is not used to populate LFIBi. It will be appreciated, of course, that according to the forwarding mechanism used, the next hop information can be, for example, in the form of the interface to the next hop, the next hop address or any other appropriate identifier.

For example with reference to FIG. 5A, LFIB 1 for topology 1 has R2's ingress label L_{R2}1, R3 as next hop and egress label L_{R3} advertised by R3. FIG. 5B shows LFIB 2 for topology 2 which has, once again, R2's ingress label L_{R2}1 together with next hop R5 and egress label L_{R5} advertised by R5. Again it will be seen that the same ingress label is used in both cases as they are from a common FEC, i.e. packets destined for node B.

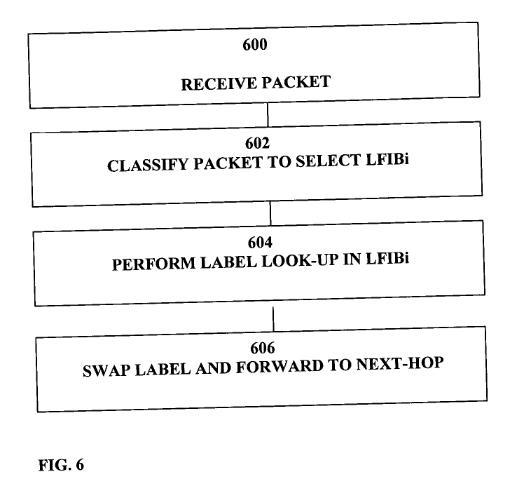

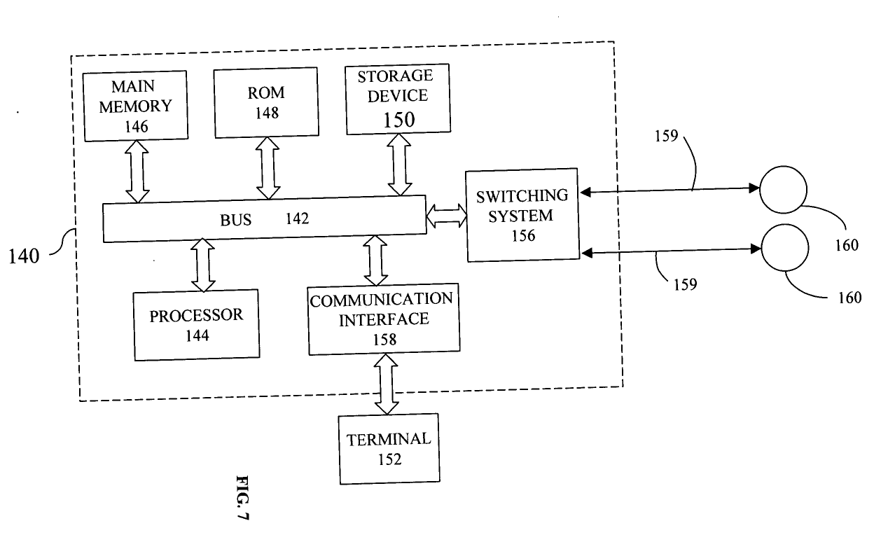

Referring now to FIG. 6 which is a flow diagram illustrating steps involved in forwarding a label switched data packet, at step 600 the packet is received at a router for example router R2. At step 602 the packet is classified to identify the topology MT-IDi and select the corresponding LFIBi. At step 604 the label lookup is performed in the correct LFIBi as at step 606 the appropriate forwarding steps are performed, for example comprising swapping the ingress for the egress label and forwarding to the next hop. For example the look up can be carried out according to an ordered operation in the forwarding mechanism with first a classification for example based on the relevant field of the packet such as EXP which identifies the LFIBi, and second a label lookup in the LFIBi. Alternatively, however, a single lookup can be performed based on both the classification and the label into a single forwarding structure. Any alternative forwarding mechanism and manner of populating the forwarding structure can be used which results in the same functional behavior.

It will further be seen that in relation to the ingress and egress label edge routers to the MPLS network R1, R4 respectively, the steps described above with reference to FIGS. 2 and 3 are implemented as appropriate. For example at the ingress router, incoming packets are received according to any appropriate protocol such as IGP or BGP and, as such, the ingress router will not carry out the label advertisement steps to upstream routers. However the ingress router will assign an incoming packet to an FEC and attach the correct egress label received from each appropriate downstream router. In a similar manner the egress router will forward the packet according to any appropriate protocol such as IGP or BGP and so will not receive label advertisements from downstream routers or attach egress labels when forwarding packets to its downstream routers but will advertise its own labels to upstream routers. Accordingly a packet received at the egress label edge may be forwarded to the next hop through an LFIB lookup keyed on its ingress label as per the appropriate forwarding mechanism and will have its ingress label stack entry removed. Alternatively, the packet received at the egress label edge router may be forwarded to the next hop through a forwarding lookup based on information contained in the header of the transported packet (e.g. Destination address in the IP header) in which case the forwarding decision also involves classification of the packet for determination of the topology as per Multi-Topology Routing methods.

As a result of the approach described above, class-based forwarding is achieved in an MPLS network along class-based paths established by MTR routing without any modification to existing label distribution protocols and using the same number of labels as though MTR were not being used as, for a given FEC, the same label can be used in all the per-topology FIBs.

In some instances, however, modification of the label distribution procedures and operations are necessary dependent on the label distribution method and label distribution control mode adopted of which various types are described in RFC3031. The techniques described above are operable, for example, in the case of downstream unsolicited/independent label distribution. In the case of downstream on-demand/independent label distribution router R2 operates as described above except that it simply needs to request label binding from each of its neighbors which is a next hop in any of the topologies, but otherwise as described in RFC3031. In the case of ordered mode, it may be appropriate that each router will only advertise a label for an FEC when it has received label binding for that FEC from all routers which are next hop for that FEC in any topology ensuring that a label is only advertised to a node when the corresponding label switch path is completely built downstream from that node and thus ready for transmission from that node. It will be appreciated that any other appropriate label distribution procedure can be implemented and modified as appropriate to enable the method described herein to take place.

The mechanisms by which the method and optimizations discussed above are implemented will be well known to the skilled reader and do not require detailed discussion here. For example the manner in which the repair paths are computed, the MPLS labels pushed and exchanged and packets forwarded along the repair path can be implemented in any appropriate manner such as hardware or software and using for example micro-code.

The method described herein can be implemented on any appropriate platform for example an IOS (internet operating system) or IOS-XR router supporting MPLS. On hardware platforms appropriate upgrade of hardware/firmware may be required to allow support of the new label switching mechanism based on per-topology LFIBs as will be apparent to the skilled reader. The method described herein can be applied in the case of any MPLS implementation for example MPLS-VPN (virtual private network) service.

4.0 Implementation Mechanisms—Hardware Overview

FIG. 7 is a block diagram that illustrates a computer system 40 upon which the method may be implemented. The method is implemented using one or more computer programs running on a network element such as a router device. Thus, in this embodiment, the computer system 140 is a router.

Computer system 140 includes a bus 142 or other communication mechanism for communicating information, and a processor 144 coupled with bus 142 for processing information. Computer system 140 also includes a main memory 146, such as a random access memory (RAM), flash memory, or other dynamic storage device, coupled to bus 142 for storing information and instructions to be executed by processor 144. Main memory 146 may also be used for storing temporary variables or other intermediate information during execution of instructions to be executed by processor 144. Computer system 140 further includes a read only memory (ROM) 148 or other static storage device coupled to bus 142 for storing static information and instructions for processor 144. A storage device 150, such as a magnetic disk, flash memory or optical disk, is provided and coupled to bus 142 for storing information and instructions.

A communication interface 158 may be coupled to bus 142 for communicating information and command selections to processor 144. Interface 158 is a conventional serial interface such as an RS-232 or RS-422 interface. An external terminal 152 or other computer system connects to the computer system 140 and provides commands to it using the interface 158. Firmware or software running in the computer system 140 provides a terminal interface or character-based command interface so that external commands can be given to the computer system.

A switching system 156 is coupled to bus 142 and has an input interface and a respective output interface (commonly designated 159) to external network elements. The external network elements may include a plurality of additional routers 160 or a local network coupled to one or more hosts or routers, or a global network such as the Internet having one or more servers. The switching system 156 switches information traffic arriving on the input interface to output interface 159 according to pre-determined protocols and conventions that are well known. For example, switching system 156, in cooperation with processor 144, can determine a destination of a packet of data arriving on the input interface and send it to the correct destination using the output interface. The destinations may include a host, server, other end stations, or other routing and switching devices in a local network or Internet.

The computer system 140 implements as a router acting as an enabling node the above described method of enabling routing. The implementation is provided by computer system 140 in response to processor 144 executing one or more sequences of one or more instructions contained in main memory 146. Such instructions may be read into main memory 146 from another computer-readable medium, such as storage device 150. Execution of the sequences of instructions contained in main memory 146 causes processor 144 to perform the process steps described herein. One or more processors in a multi-processing arrangement may also be employed to execute the sequences of instructions contained in main memory 146. In alternative embodiments, hard-wired circuitry may be used in place of or in combination with software instructions to implement the method. Thus, embodiments are not limited to any specific combination of hardware circuitry and software.

The term “computer-readable medium” as used herein refers to any medium that participates in providing instructions to processor 144 for execution. Such a medium may take many forms, including but not limited to, non-volatile media, volatile media, and transmission media. Non-volatile media includes, for example, optical or magnetic disks, such as storage device 150. Volatile media includes dynamic memory, such as main memory 146. Transmission media includes coaxial cables, copper wire and fiber optics, including the wires that comprise bus 142. Transmission media can also take the form of wireless links such as acoustic or electromagnetic waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 144 for execution. For example, the instructions may initially be carried on a magnetic disk of a remote computer. The remote computer can load the instructions into its dynamic memory and send the instructions over a telephone line using a modem. A modem local to computer system 140 can receive the data on the telephone line and use an infrared transmitter to convert the data to an infrared signal. An infrared detector coupled to bus 142 can receive the data carried in the infrared signal and place the data on bus 142. Bus 142 carries the data to main memory 146, from which processor 144 retrieves and executes the instructions. The instructions received by main memory 146 may optionally be stored on storage device 150 either before or after execution by processor 144.

Interface 159 also provides a two-way data communication coupling to a network link that is connected to a local network. For example, the interface 159 may be an integrated services digital network (ISDN) card or a modem to provide a data communication connection to a corresponding type of telephone line. As another example, the interface 159 may be a local area network (LAN) card to provide a data communication connection to a compatible LAN. Wireless links may also be implemented. In any such implementation, the interface 159 sends and receives electrical, electromagnetic or optical signals that carry digital data streams representing various types of information.

The network link typically provides data communication through one or more networks to other data devices. For example, the network link may provide a connection through a local network to a host computer or to data equipment operated by an Internet Service Provider (ISP). The ISP in turn provides data communication services through the worldwide packet data communication network now commonly referred to as the “Internet”. The local network and the Internet both use electrical, electromagnetic or optical signals that carry digital data streams. The signals through the various networks and the signals on the network link and through the interface 159, which carry the digital data to and from computer system 140, are exemplary forms of carrier waves transporting the information.

Computer system 140 can send messages and receive data, including program code, through the network(s), network link and interface 159. In the Internet example, a server might transmit a requested code for an application program through the Internet, ISP, local network and communication interface 158. One such downloaded application provides for the method as described herein.

The received code may be executed by processor 144 as it is received, and/or stored in storage device 150, or other non-volatile storage for later execution. In this manner, computer system 140 may obtain application code in the form of a carrier wave.

5.0 Extensions and Alternatives

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method of enabling routing of label switched data packets in a data communications network comprising a plurality of nodes and supporting multiple topologies, the method being performed at an enabling node and comprising constructing a per-topology label forwarding table.

2. A method as claimed in claim 1 in which the enabling node populates each label forwarding table with forwarding information for a forwarding class in that topology.

3. A method as claimed in claim 2 in which the forwarding information includes the enabling nodes ingress label for the forwarding class, next hop information for the forwarding class in the corresponding topology, and, as the egress label, the label advertised by the next hop for the forwarding class.

4. A method as claimed in claim 3 in which the next hop information is derived from a multiple topology—aware routing table.

5. A method as claimed in claim 2 in which the forwarding class comprises a forwarding equivalent class.

6. A method as claimed in claim 1 in which the network comprises a multi-protocol label switched network.

7. A method as claimed in claim 1 in which the label forwarding table comprises a label forwarding information base.

8. A method as claimed in claim 2 further comprising the steps of receiving a label switched data packet, classifying the label switched data packet to identify the topology along which it is forwarded, performing a lookup in the corresponding label forwarding table to derive the forwarding information, and forwarding the label switched packet according to the forwarding information.

9. A computer readable medium comprising one or more sequences of instructions for enabling routing of label switched data packets which, when executed by one or more processors, cause the one or more processors to perform the steps of the method of claim 1.

10. An apparatus for enabling routing of label switched data packets in a data communications network comprising a plurality of nodes and supporting multiple topologies comprising means for constructing a per-topology label forwarding table.

11. An apparatus for enabling routing of label switched data packets, the apparatus comprising:
one or more processors; and
a network interface communicatively coupled to the one or more processors and configured to communicate one or more packet flows among the one or more processors in a network and a computer readable medium comprising one or more sequences of instructions for enabling routing of label switched data packets which, when executed by the one or more processors, cause the one or more processors to perform the steps of the method of claim 1.
